(19) United States
(12) Patent Application Publication
(10) Pub. No.: US 2023/0057599 A1
(43) Pub. Date: Feb. 23, 2023

(54) START-UP SEQUENCE FOR GASEOUS FUEL ENGINE

(71) Applicant: PRATT & WHITNEY CANADA CORP., Longueuil (CA)

(72) Inventors: Thomas DILLON, Etobicoke (CA); Todd MILLER, Toronto (CA)

(21) Appl. No.: 17/406,655

(22) Filed: Aug. 19, 2021

(51) Int. Cl. F02C 7/264; F02C 7/22

(52) U.S. Cl. CPC F02C 7/264; F02C 7/22; F05D 2220/32; F05D 2240/35

(57) ABSTRACT

Methods and systems for starting an engine are described. The method comprises a manifold purging phase where the at least one fuel manifold is filled with an inert gas; a manifold fuel filling phase, where fuel flows into the at least one manifold and blends with the inert gas as the engine rotates, and the inert gas is subsequently turned off; and an ignition phase, where the fuel flowing from the at least one manifold into the combustor is ignited and light-up is detected.

### TECHNICAL FIELD

The disclosure relates generally to engines that operate with a gaseous fuel system.

### BACKGROUND OF THE ART

Fuels which exist in the liquid state at room temperature are called liquid fuels. Examples of liquid fuels are kerosene, petrol and diesel. Fuels that exist in the gaseous state at room temperature are called gaseous fuels. Examples of gaseous fuels are hydrogen gas, natural gas, butane and propane. Gas turbine engines in the aerospace industry have long been designed to operate with liquid fuels. There is growing interest in using zero carbon fuel, such as hydrogen, to propel aircraft. While the methods of operating aircraft engines based on liquid fuel are suitable for their purposes, improvements are needed to adapt to gaseous fuel.

### SUMMARY

In one aspect, there is provided a method for starting an engine coupled to a fuel system having at least one fuel manifold configured to supply fuel to a combustor of the engine. The method comprises a manifold purging phase where the at least one fuel manifold is filled with an inert gas; a manifold fuel filling phase, where fuel flows into the at least one manifold and blends with the inert gas as the engine rotates, and the inert gas is subsequently turned off; and an ignition phase, where the fuel flowing from the at least one manifold into the combustor is ignited and light-up is detected.

In another aspect, there is provided a system for starting an engine coupled to a fuel system having at least one fuel manifold configured to supply fuel to a combustor of the engine. The system comprises a processor and a non-transitory computer-readable medium having stored thereon program code. The program code is executable by the processor for performing a manifold purging phase where the at least one fuel manifold is filled with an inert gas; a manifold fuel filling phase, where fuel flows into the at least one manifold and blends with the inert gas as the engine rotates, and the inert gas is subsequently turned off; and an ignition phase, where the fuel flowing from the at least one manifold into the combustor is ignited and light-up is detected.

### DESCRIPTION OF THE DRAWINGS

Reference is now made to the accompanying figures in which:

FIG. 1 is a schematic cross sectional view of an example gas turbine engine;

FIG. 2A is a block diagram of an example fuel system for gaseous fuel;

FIG. 2B is a block diagram of an example fuel system for gaseous and liquid fuel;

FIG. 3 is a flowchart of a method for starting an engine with an integrated manifold purge using inert gas;

FIG. 4 is a timing diagram of various signals involved in an engine starting sequence; and

FIG. 5 is a block diagram of an example computing device.

### DETAILED DESCRIPTION

The present disclosure is directed to methods and systems for operating an engine coupled to a fuel system having at least one fuel manifold configured to supply gaseous fuel to a combustor of the engine. Fuels that exist in the gaseous state at room temperature are called gaseous fuels. Examples of gaseous fuels are hydrogen gas, natural gas, butane and propane. The properties of gaseous fuel differ from the properties of liquid fuel. For example, gaseous fuel is less dense than air and therefore, unburnt gaseous fuel cannot be drained via a gravity-based manifold purging system or a scavenging system as used with tradition liquid fuels. Residual gaseous fuel remaining in the manifold can cause instability and/or damage upon engine start. There are described herein methods and system for integrating a manifold purge based on inert gas into an engine start sequence.

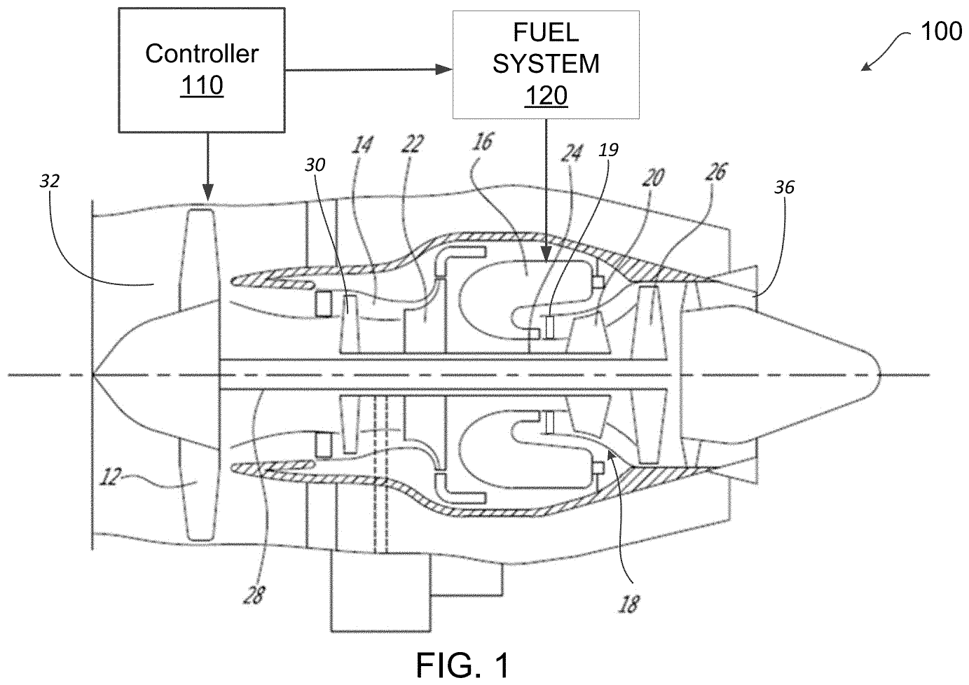

FIG. 1 illustrates an example engine 100 of a type provided for use in subsonic flight. The engine 100 of FIG. 1 is a turbofan engine that generally comprises, in serial flow communication, a fan 12 through which ambient air is propelled toward an inlet 32, a compressor section 14 for pressurizing the air, a combustor 16 in which the compressed air is mixed with fuel and ignited for generating an annular stream of hot combustion gases, and a turbine section 18 for extracting energy from the combustion gases, which exit via an exhaust 36. High-pressure rotor(s) of the turbine section 18 (referred to as “HP turbine rotor(s) 20”) are mechanically linked to high-pressure rotor(s) of the compressor section 14 (referred to as “HP compressor rotor(s) 22”) through a high-pressure shaft 24. The turbine section 18 includes a vane 19 between the combustor 16 and the HP turbine rotor(s) 20. Low-pressure rotor(s) of the turbine section 18 (referred to as “LP turbine rotor(s) 26”) are mechanically linked to the low-pressure rotor(s) of the compressor section 14 (referred to as “LP compressor rotor(s) 30”) and/or the fan rotor 12 through a concentric low-pressure shaft 28 extending within the high-pressure shaft 24 and rotating independently therefrom.

Although FIG. 1 illustrates the engine 100 as a turbofan engine, it should be noted that the techniques described herein are applicable to other types of gas turbine engines, including turboshaft, turboprop, and turbojet engines, and to other types of combustion engines, including Wankel engines and reciprocating engines. As such, the expression “combustor” should be understood to include any chamber within an engine in which combustion can occur. In some embodiments, the engine forms part of an aircraft. In some embodiments, the engine forms part of a vehicle for land or marine applications. In some embodiments, the engine is used in an industrial setting, for example for power generation or as an auxiliary power unit.

Control of the operation of the engine 100 can be effected by one or more control system, for example a controller 110, which is communicatively coupled to the engine 100. The operation of the engine 100 can be controlled by way of one or more actuators, mechanical linkages, hydraulic systems, and the like. The controller 110 can be coupled to the actuators, mechanical linkages, hydraulic systems, and the like, in any suitable fashion for effecting control of the engine 100. The controller 110 can modulate the position and orientation of variable geometry mechanisms within the engine 100, the bleed level of the engine 100, and fuel flow, based on predetermined schedules or algorithms. In some embodiments, the controller 110 includes one or more FADEC(s), electronic engine controller(s) (EEC(s)), or the like, that are programmed to control the operation of the engine 100.

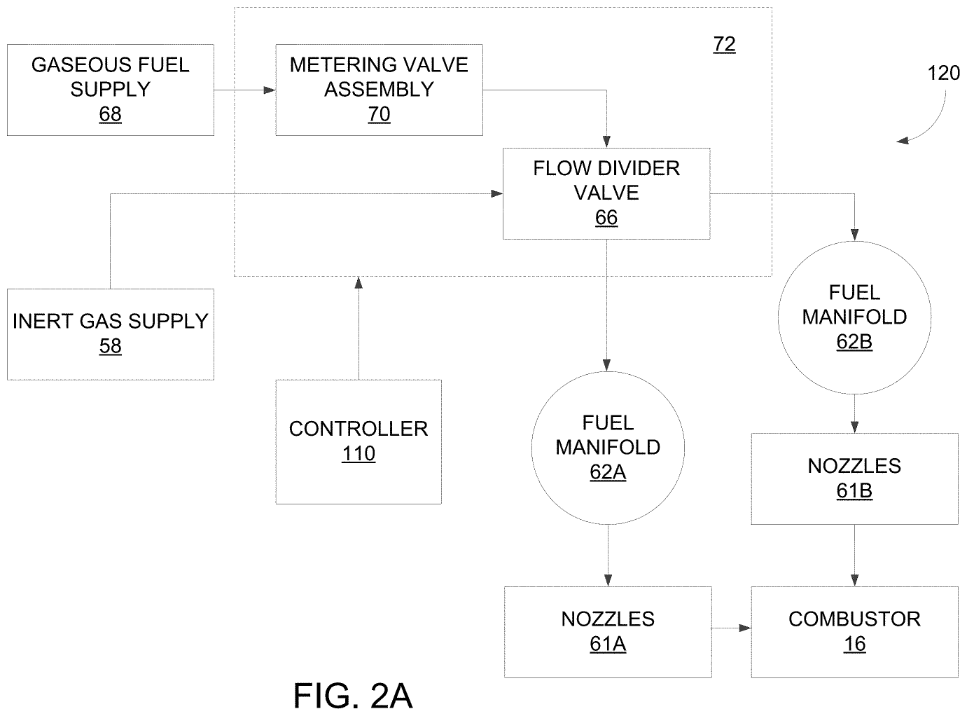

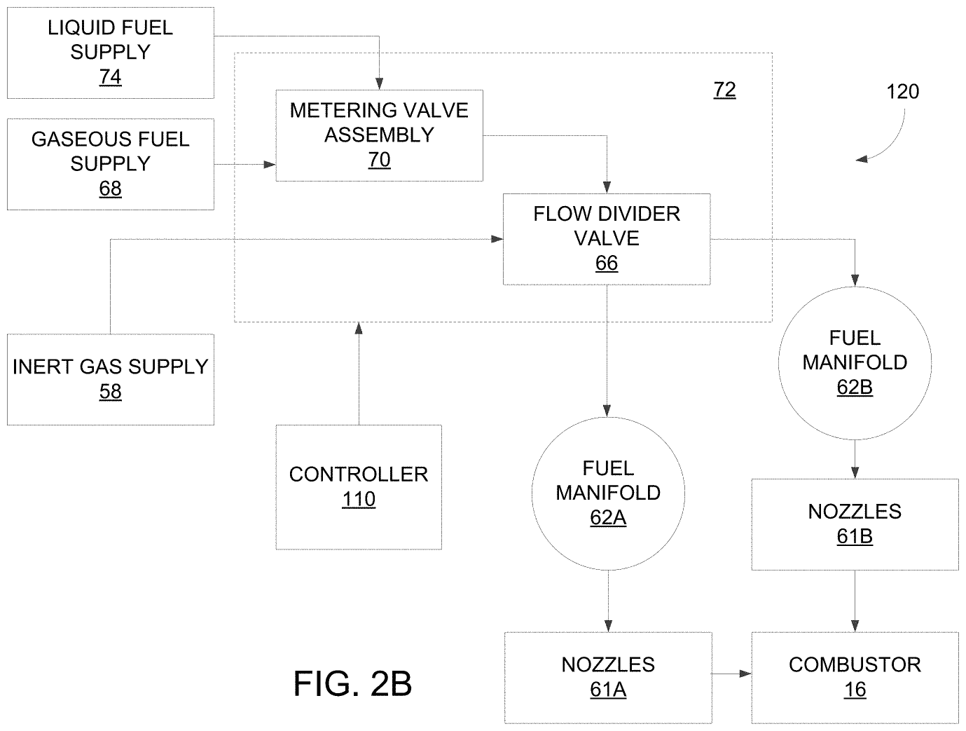

The controller 110 is configured to regulate fuel flow provided to the engine 100 via a fuel system 120. FIG. 2A is a schematic illustration of an example of the fuel system 120. The fuel system 120 has at least one fuel manifold configured to supply gaseous fuel to a combustor of the engine. In the illustrated embodiment, a first fuel manifold 62A is fluidly connected between a gaseous fuel supply 68 and a combustor 16 of the engine 100. A second fuel manifold 62B is fluidly connected between the gaseous fuel supply 68 and the combustor 16 of the engine 100. Although two fuel manifolds 62A, 62B are illustrated, a single manifold or more than two manifolds may be present. The fuel manifolds 62A, 62B may be interconnected or independent from one another and/or from other fuel manifolds. The fuel manifolds 62A, 62B may supply gaseous fuel to the combustor 16 via one or more sets of fuel nozzles 61A, 61B, respectively. In some embodiments, first and second sets of fuel nozzles 61A, 61B may be substantially the same or different. In some operating situations, different amounts of gaseous fuel may be supplied to each fuel manifold.

The gaseous fuel is provided to the respective fuel manifolds 62A, 62B through an arrangement 72 of components such as valves, valve controllers, pressure transducers, pressure regulators, and the like. The arrangement 72 may be configurable (e.g., actuatable) between a plurality of gaseous fuel configurations to selectively provide gaseous fuel to the fuel manifold 62A, the fuel manifold 62B, and/or both. The arrangement 72 may include a metering valve assembly 70, which may include one or more solenoid-operated valves, one or more one-way valves, one or more (pressure or flow) regulator, flow diverter valve(s), and/or any other flow control device(s) configured to permit/stop/regulate fluid flow or pressure across the arrangement 72. In some embodiments, the arrangement 72 comprises one or more flow divider valve 66 that may or may not be part of the metering valve assembly 70. The flow divider valve 66 may be a hydraulic device, an electronic device or an electronically-controlled hydraulic device that can separate a flow into two or more parts. The arrangement 72 and/or flow divider valve 66 may comprise one or more embodiments of (flow divider) valves, or assemblies.

The arrangement 72 may be configured to supply gaseous fuel from the gaseous fuel supply 68 to the first and second fuel manifolds 62A, 62B in a first gaseous fuel configuration of the components of the arrangement 72. The arrangement 72 may be configured to supply gaseous fuel to the first fuel manifold 62A and stop supplying gaseous fuel to the second fuel manifold 62B in a second gaseous fuel configuration of the components of the arrangement 72. The arrangement 72 may be configured to stop supplying gaseous fuel to the first fuel manifold 62A and supply gaseous fuel to the second fuel manifold 62B in a third gaseous fuel configuration of the components of the arrangement 72. The gaseous fuel supply 68 may be configured to provide fuel flow to the first and second fuel manifolds 62A, 62B via the metering valve assembly 70 and the flow divider valve 66. The flow divider valve 66 may supply gaseous fuel to the first fuel manifold 62A via a first downstream fuel line, and to the second fuel manifold 62B via a second downstream fuel line. A fuel pump may be operatively disposed between the gaseous fuel supply 68 and the flow divider valve 66, for example as part of the arrangement 72 or externally thereto.

When the engine 100 is active (i.e. is in operation), gaseous fuel is supplied to the combustor 16 from the gaseous fuel supply 68 to at least one fuel manifold 62A, 62B. An “active” engine, also known as being in a running state, is when the combustor is lit and the engine core is spinning. When the engine is inactive (i.e. is not in operation), at least one of the fuel manifolds 62A, 62B, is purged by supplying inert gas from an inert gas supply 58 to a respective one of the fuel manifolds 62A, 62B. An inactive engine refers to the state of the engine prior to ignition, such that no fuel is consumed and no output power is generated. The inert gas supply 58 is fluidly connected to the fuel manifolds 62A, 62B via the arrangement 72. The arrangement 72 may be configured to supply inert gas from the inert gas supply 58 to the first and/or second fuel manifold 62A, 62B in one or more purging configuration of the arrangement 72. As used herein, “inert gas” is understood to mean a non-combustible gas which may be composed of a) a single non-combustible gas; b) a mixture of non-combustible gases; or c) a mixture of non-combustible gas(es) and reactive gas(es) where the overall mixture is non-combustible. Examples of inert gases are Nitrogen, Argon, and Helium.

In some embodiments, and as shown in FIG. 2A, the inert gas supply 58 may be coupled to the flow divider valve 66 such that gaseous fuel and inert gas are selectively provided to the fuel manifolds 62A, 62B. Alternatively, a separate and independent valve or valve assembly within the arrangement 72 may be used to allow the inert gas to flow from the inert gas supply 58 to the first and/or second manifold 62A, 62B, while the flow divider valve 66 and/or the metering valve assembly 70 and/or other components of the arrangement 72 are configured to stop flow of gaseous fuel from the gaseous fuel supply 68 to the first and/or second manifold 62A, 62B.

In some embodiments, and as shown in FIG. 2B, the fuel system 120 may be a dual fuel system, such that liquid fuel and gaseous fuel may be selectively used to operate the engine. Liquid fuel may be provided from a liquid fuel supply 74 to the fuel manifold 62A, the fuel manifold 62B, or both, via the arrangement 72. The arrangement 72 may be configured to supply liquid fuel from the liquid fuel supply 74 to the first manifold 62A in a first liquid fuel configuration of components of the arrangement 72. The arrangement 72 may be configured to supply liquid fuel from the liquid fuel supply 74 to the second manifold 62B in a second liquid fuel configuration of components of the arrangement 72. The arrangement 72 may be configured to supply liquid fuel from the liquid fuel supply 74 to the first manifold 62A and the second manifold 62B in a third liquid fuel configuration of components of the arrangement 72.

In some embodiments, the metering valve assembly 70 is dedicated to the gaseous fuel supply 68 and a separate metering valve assembly is provided for the liquid fuel supply 74 as part of the arrangement 72. Alternatively, the metering valve assembly 70 is shared between the liquid fuel supply 74 and the gaseous fuel supply 68 and configurable to permit/stop/regulate gaseous fuel flow and liquid fuel flow. In some embodiments, the flow divider valve 66 is dedicated to the gaseous fuel supply 68 and a separate flow divider valve is provided for the liquid fuel supply 74 as part of the arrangement 72. Alternatively, the flow divider valve 66 is shared between the liquid fuel supply 74 and the gaseous fuel supply 68 and configurable to permit/stop/regulate gaseous fuel flow and liquid fuel flow into each manifold. In some embodiments, the flow divider valve 66 is shared between the liquid fuel supply 74, the gaseous fuel supply 68, and the inert gas supply 58. In some embodiments, a separate flow divider valve is shared between the liquid fuel supply 74 and the inert gas supply 58. In some embodiments, each one of the liquid fuel supply, the gaseous fuel supply, and the inert gas supply 58 has a dedicated flow divider valve as part of the arrangement 72. Each dedicated flow divider valve may be fluidly connected to the first manifold 62A and the second manifold 62B for selectively permitting/stopping fluid flow therethrough. In some embodiments, liquid fuel from the liquid fuel supply 74 is used to supply the metering valve assembly 70 with hydraulic power, for example in a closed loop circulatory system. In particular, a metering valve within the metering valve assembly 74 may be actuated with liquid fuel as a source of hydraulic pressure.

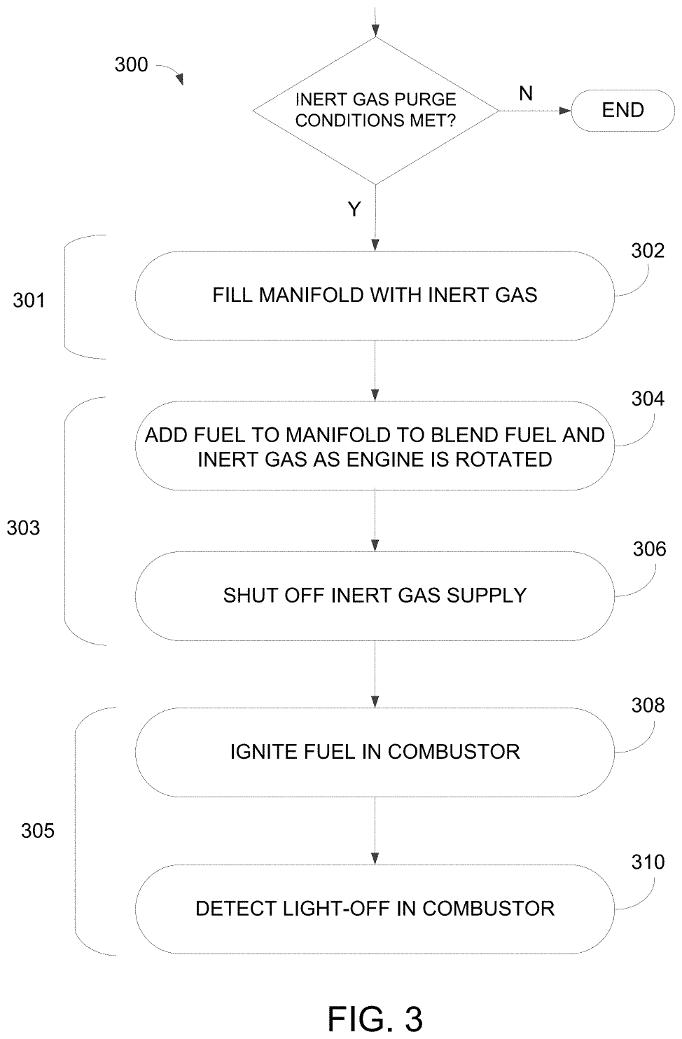

As disclosed herein, a manifold purge using inert gas is integrated as part of an engine start sequence. Reference is made to FIG. 3, illustrating an example method 300 of starting an engine with an integrated manifold purge. The method 300 is composed of three phases: a manifold purging phase 301, a manifold fuel filling phase 303, and an engine ignition phase 305. In the manifold purging phase 301, one or more of the manifolds 62A, 62B is filled with the inert gas at step 302. The controller 110 sets the arrangement 72 of components to one or more configurations so as to allow inert gas to flow from the inert gas supply 58 into the one or more manifolds 62A, 62B. In some embodiments, the manifolds 62A, 62B are filled with inert gas concurrently, using a first configuration of the arrangement 72 of components. In some embodiments, the manifolds 62A, 62B are filled sequentially, using a first configuration and a second configuration of the arrangement 72. In some embodiments, only the first manifold 62A is filled with the inert gas, and the second manifold 62B is isolated from the inert gas, or vice versa. In some other embodiments, manifolds 62A and 62B are interconnected and the inert gas will flow into one of the two manifolds, for example 62B, through the other of the two manifolds, for example 62A. Other scenarios for filling the one or more manifolds of inert gas may also apply.

The manifold fuel filling phase 303 occurs after the manifold purging phase 301. In the manifold fuel filling phase 303, fuel is allowed to flow into the one or more manifolds 62A, 62B and blend with the inert gas as the engine rotates, at step 304, and the inert gas is subsequently turned off at step 306. Stated differently, fuel begins to flow into the fuel manifold(s) before the inert gas supply 58 is turned off, such that both fuel and inert gas are flowing into the fuel manifold at step 304. The blending of the inert gas and the fuel in the fuel system 120 prevents air from getting into the fuel system 120 and allows a smooth transition between the purging phase 301 and the manifold fuel filling phase 303. Once the inert gas supply 58 is turned off at step 306, and while fuel continues to flow into the manifold(s), the proportion of fuel in the manifold will increase as the proportion of inert gas decreases, until only fuel is left in the fuel manifold.

When the manifold(s) are sufficiently filled with fuel and the fuel flows into the combustor, the method 300 transitions to the ignition phase 305, where fuel flowing from the one or more manifolds 62A, 62B into the combustor is mixed with air, ignited and light-off is detected. In some embodiments, the rate of flow of the fuel is transitioned from a first flow rate to a second flow rate in preparation for igniting the fuel in the combustor. A high first flow rate may be used to fill the manifold(s) and a lower second flow rate may be used to prior to ignition. The specific flow rates may be determined based on engine specifications and other parameters, as is well understood by those skilled in the art. The fuel in the combustor mixes with compressed air and at step 308, the mixture is ignited and hot combustion gases are generated. At step 310, light-off is detected when sufficient combustion gases are produced. Any ignition and light-off detection techniques may be used.

It will be understood that initiating of the rotation of the engine, also referred to as an “engine crank” may take place as part of the manifold purging phase 301 or part of the manifold fuel filling phase 303. It will also be understood that the fuel flowing into the manifold at step 304 may be gaseous fuel or liquid fuel. In some embodiments, the method 300 is performed regardless of fuel type used to operate the engine. In some embodiments, the method 300 is performed after a previous operation of the engine used gaseous fuel. In some embodiments, the fuel system is a gaseous fuel system (instead of a dual fuel system) and therefore the method 300 is performed at every engine start-up or at engine starts of a certain type (e.g. under normal conditions, or on-ground engine starts). These criteria, as well as others, may be used as a set of conditions to be met in order to perform the manifold purge with inert gas as part of the start-up sequence. For example, a determination may be made as to whether one or more condition for performing the inert gas purge is met. If so, the method 300 is initiated at step 302. If conditions for inert gas purging are not met, the method 300 is not initiated and a regular engine start-up is performed.

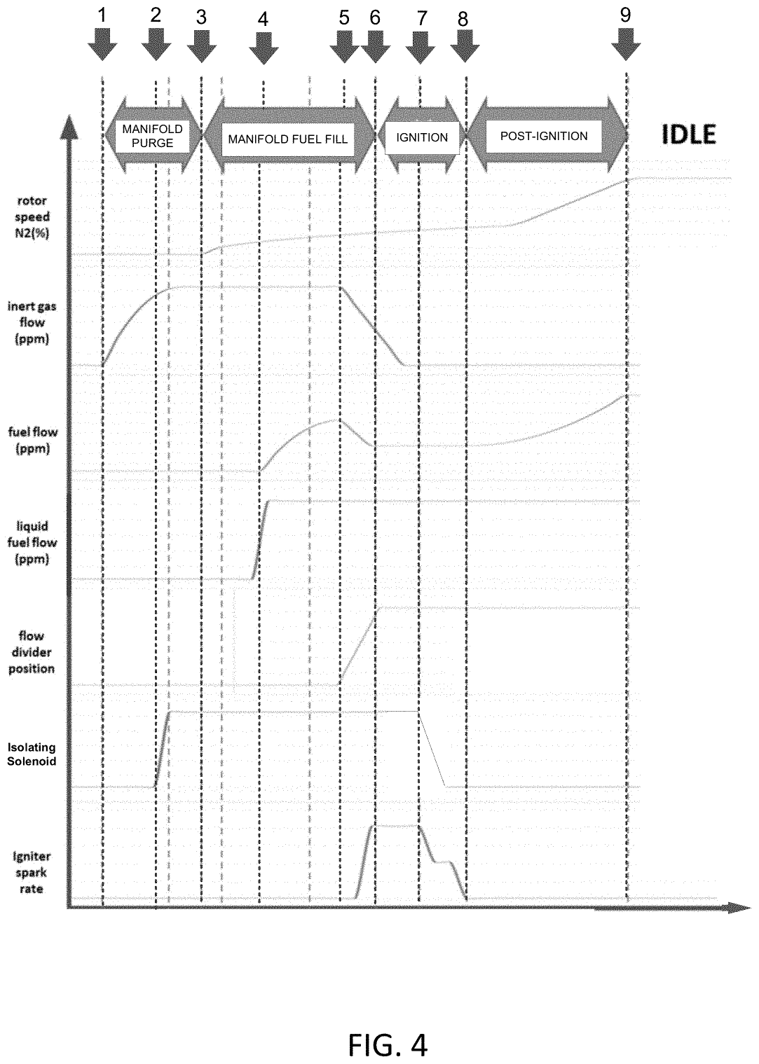

A specific and non-limiting example of the method 300 is illustrated with the timing diagram of FIG. 4. Various time steps are numbered and overlaid on a plurality of signals to illustrate an example embodiment for a starting sequence. In this example, two manifolds are present and the inert gas supply and fuel supply share a flow divider valve upstream from the manifolds, as illustrated in FIG. 2A. At time step 1, the controller 110 triggers flow of the inert gas into the fuel system 120, and the arrangement 72 of the components is configured to allow the inert gas to flow into the first and second manifolds, in order to purge the manifolds of fuel and/or air. At time step 2, an isolating solenoid is energized in order to isolate the second manifold from fuel flow, for example manifold 62B. Only the first manifold will be used for the engine start. At time step 3, rotation of the engine is initiated, as shown by the rotor speed N2 that begins to increase. As previously indicated, initiation of the rotation of the engine may form part of the manifold purging phase or the manifold filling phase.

At time step 4, fuel (liquid or gaseous) begins to flow into the fuel system 120 and liquid fuel is placed into a closed loop circulatory system in order to supply the fuel metering valve with hydraulic power. As fuel flow ramps up, inert gas flow remains steady and continues to flow into the first manifold until time step 5, where the flow divider position changes from a position where inert gas is permitted to flow into the manifold to a position where inert gas is blocked from flowing into the manifold. Fuel flow is also ramped down to an open-loop flow rate associated with an engine start. At time step 6, a high frequency pulse is used to generate an ignition spark in the combustor. At time step 7, light-off is detected and the isolating solenoid is de-energized to allow fuel to flow into the second manifold. At time step 8, a post-ignition phase begins, whereby fuel flow is modulated in accordance with a closed-loop sub-idle acceleration schedule until the engine reaches an idle state at time step 9. It will be understood that the present method 300 for starting an engine with an integrated manifold purge is independent of the ignition and light-off detection methods used, as well as the post-ignition acceleration schedule used to reach an engine idle state. Based on the techniques described herein, a manifold purge is performed using inert gas in order to purge gaseous fuel that may be present in the manifold.

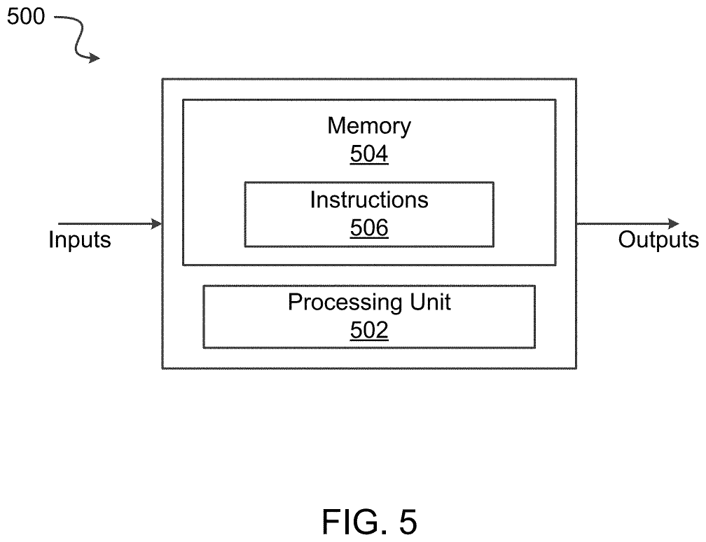

With reference to FIG. 5, there is illustrated an embodiment of a computing device 500 for implementing part or all of the method 300 described above. The computing device 500 can be used to perform part or all of the functions of the controller 110 of the engine 100. In some embodiments, the controller 110 is composed only of the computing device 500. In some embodiments, the computing device 500 is within the controller 110 and cooperates with other hardware and/or software components within the controller 110. In both cases, the controller 110 performs the method 300. In some embodiments, the computing device 500 is external to the controller 110 and interacts with the controller 110. In some embodiments, some hardware and/or software components are shared between the controller 110 and the computing device 500, without the computing device 500 being integral to the controller 110. In this case, the controller 110 can perform part of the method 300.

The computing device 500 comprises a processing unit 502 and a memory 504 which has stored therein computer-executable instructions 506. The processing unit 502 may comprise any suitable devices configured to cause a series of steps to be performed such that instructions 506, when executed by the computing device 500 or other programmable apparatus, may cause the functions/acts/steps specified in the method 300 described herein to be executed. The processing unit 502 may comprise, for example, any type of general-purpose microprocessor or microcontroller, a digital signal processing (DSP) processor, a CPU, an integrated circuit, a field programmable gate array (FPGA), a reconfigurable processor, other suitably programmed or programmable logic circuits, or any combination thereof.

The memory 504 may comprise any suitable known or other machine-readable storage medium. The memory 504 may comprise non-transitory computer readable storage medium, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to device, for example random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like. Memory 504 may comprise any storage means (e.g., devices) suitable for retrievably storing machine-readable instructions 506 executable by processing unit 502.

It should be noted that the computing device 500 may be implemented as part of a FADEC or other similar device, including an electronic engine control (EEC), engine control unit (EUC), engine electronic control system (EECS), an Aircraft Avionics System, and the like. In addition, it should be noted that the techniques described herein can be performed by a computing device 500 substantially in real-time.

The methods and systems described herein may be implemented in a high level procedural or object oriented programming or scripting language, or a combination thereof, to communicate with or assist in the operation of a computer system, for example the computing device 500. Alternatively, the methods and systems described herein may be implemented in assembly or machine language. The language may be a compiled or interpreted language. Program code for implementing the methods and systems may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon, or a computer program product. The computer program may comprise computer-readable instructions which cause a computer, or more specifically the processing unit 502 of the computing device 500, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the method 300 may be combined with known manifold purging systems for liquid fuel, and/or with a manifold venting system (e.g. using a multi-directional valve to vent gaseous fuel to the atmosphere). Yet further modifications could be implemented by a person of ordinary skill in the art in view of the present disclosure, which modifications would be within the scope of the present technology.

1. A method for starting an engine coupled to a fuel system having at least one fuel manifold configured to supply fuel to a combustor of the engine, the method comprising:
a manifold purging phase where the at least one fuel manifold is filled with an inert gas;
a manifold fuel filling phase, where the fuel flows into the at least one manifold and blends with the inert gas as the engine rotates, the inert gas and the fuel allowed to flow into the at east on fuel manifold during the manifold fuel filling phase, and the inert gas is subsequently turned off; and
an ignition phase, where the fuel flowing from the at least one manifold into the combustor is ignited and light-up is detected.

2. The method of claim 1, wherein the fuel is a gaseous fuel.

3. The method of claim 1, wherein the fuel system is a dual fuel system for gaseous fuel and liquid fuel.

4. The method of claim 1, wherein the inert gas is turned off by switching a common flow-diverter valve from the inert gas to the fuel.

5. The method of claim 1, wherein the at least one manifold comprises a first manifold and a second manifold, and wherein the manifold purging phase comprises filling the first manifold and the second manifold with the inert gas.

6. The method of claim 5, wherein the manifold fuel filling phase comprises flowing the fuel into the first manifold and isolating the second manifold from the fuel, and wherein the ignition phase comprises allowing the fuel to flow into the second manifold post-light-up.

7. (canceled)

8. The method of claim 1, wherein the at least one manifold comprises a plurality of manifolds, and the plurality of manifolds are filled with the inert gas concurrently.

9. The method of claim 1, further comprising determining that one or more conditions for an inert gas manifold purge are met prior to initiating the manifold purging phase.

10. The method of claim 1, wherein the manifold fuel filling phase comprises reducing a flow rate of the fuel flow prior to igniting the fuel in the combustor.

11. A system for starting an engine coupled to a fuel system having at least one fuel manifold configured to supply fuel to a combustor of the engine, the system comprising:
a processor; and
a non-transitory computer-readable medium having stored thereon program code executable by the processor for:
a manifold purging phase where the at least one fuel manifold is filled with an inert gas;
a manifold fuel filling phase, where the fuel flows into the at least one manifold and blends with the inert gas as the engine rotates, the inert gas and the fuel allowed to flow into the at least one fuel manifold during the manifold fuel filling phase, and the inert gas is subsequently turned off; and
an ignition phase, where the fuel flowing from the at least one manifold into the combustor is ignited and light-up is detected.

12. The system of claim 11, wherein the fuel is a gaseous fuel.

13. The system of claim 11, wherein the fuel system is a dual fuel system for gaseous fuel and liquid fuel.

14. The system of claim 11, wherein the inert gas is turned off by switching a common flow-diverter valve from the inert gas to the fuel.

15. The system of claim 11, wherein the at least one manifold comprises a first manifold and a second manifold, and wherein the manifold purging phase comprises filling the first manifold and the second manifold with the inert gas.

16. The system of claim 15, wherein the manifold fuel filling phase comprises flowing the fuel into the first manifold and isolating the second manifold from the fuel, and wherein the ignition phase comprises allowing the fuel to flow into the second manifold post-light-up.

17. (canceled)

18. The system of claim 11, wherein the at least one manifold comprises a plurality of manifolds, and the plurality of manifolds are filled with the inert gas concurrently.

19. The system of claim 11, wherein the program code is further executable for determining that one or more conditions for an inert gas manifold purge are met prior to initiating the manifold purging phase.

20. The system of claim 11, wherein the manifold fuel filling phase comprises reducing a flow rate of the fuel flow prior to igniting the fuel in the combustor.

21. The method of claim 1, wherein the engine is an aircraft engine.

22. The system of claim 11, wherein the engine is an aircraft engine.
